(19) United States
(12) Patent Application Publication
(10) Pub. No.: US 2010/0153722 A1
(43) Pub. Date: Jun. 17, 2010

(54) METHOD AND SYSTEM TO PROVE IDENTITY OF OWNER OF AN AVATAR IN VIRTUAL WORLD

(75) Inventors: Frederic Bauchot, Saint-Laurent-Du-Var (FR); Gerard Marmigere, Drap (FR); Carole Truntschka, Saint-Laurent-Du-Var (FR); Florence Tressols, Saint-Laurent-Du-Var (FR)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/559,067

(22) Filed: Sep. 14, 2009

(30) Foreign Application Priority Data
Dec. 11, 2008 (EP) 08305915

(51) Int. Cl. H04L 9/32; G06F 21/00; G06F 3/048

(52) U.S. Cl. 713/168; 713/186; 715/757

(57) ABSTRACT

The present application provides an method and system for verifying a user's identity within a virtual world environment. The verification is to be in real-time and avoids the possibility of providing credential (e.g., biometric information) that were previously authentication, by sending to the user a time-sensitive challenge and requiring the user to provide the requested credentials (e.g., biometric information) within a predetermined time period. Therefore, the present invention is best positioned for environments where trusted identification of a user is needed online to facilitate secure transactions.

### CROSS-REFERENCE TO RELATED APPLICATIONS

The present application is related to a co-pending U.S. patent application Ser. No. ______ (Attorney docket: FR920080088US1) concurrently filed with the present application, which is incorporated herein by reference.

### BACKGROUND

This invention generally relates to transactions and activities in virtual world environments, and more specifically, the invention relates to methods and systems for securely identifying a person over a network, where the person is participating in a virtual world.

A virtual world (also known as the “3D Internet”) is a computer-based simulated environment where avatars (i.e., a virtual representation of a user) inhabit and interact with other avatars. In a virtual world (e.g., Active Worlds™), a human projects himself/herself into the virtual world in the form of an actor (e.g., a motional avatar) that can interact within the virtual world. Examples of virtual worlds include, but are not limited to, Second Life®, There, Eve Online and others such as Metaverse (e.g., a virtual world where humans interact with each other and software applications in three dimensional space that uses a metaphor of a real world) and MMORPGs (Massively Multiplayer Online Role-Playing Games) environments.

These virtual world environments often include imaginary characters participating in fictional events, activities and transactions. There are educational and entertainment benefits in creating new and challenging ways to relate virtual world environments with real-world experiences.

Currently, however, virtual world communities are expanding beyond education and entertainment. For example, some virtual world communities, typified by Second Life, are attracting attention and increasing in popularity—in part, by allowing various transactions to occur with real-world implications within the virtual world. In virtual world communities, however, the owner of an avatar is not easily discernable and hence, verifiable. For example, in the virtual world, a “real owner” (i.e. a human) can be represented by more than one “virtual characters” (i.e. avatars) with x, y, z coordinates that are mapped within the three-dimensional space deemed to be the virtual world.

Moreover, virtual worlds have a number of characteristics that facilitate monitoring and rating activities within the virtual world. One such characteristic is that there are always some users (perhaps residing in different time zones) participating, and hence logged onto, the virtual world. Consequently, there is a persistent presence of users and users can interact relatively easily with other users at any time. In the existing communities of users, tags or rating values may be assigned to the users (or more specifically, to the users' avatars), based on a user's interaction with others. In addition, it is easy for users to move (or “teleport”) between communities, simply by modifying the three-dimensional coordinates of an avatar. However, a group of users who do malicious actions can intentionally increase their rating values. Accordingly, such ratings cannot be trusted as a criterion of indicating correct evaluations or a person's credentials.

In addition, many users belong to a plurality of groups. In many of the existing implemented communities, admittance into a building or an island in a virtual world is controlled on a group-by-group basis (e.g., membership to a discount club that has a presence in the virtual world). Accordingly, users who do malicious actions often belong to a certain group (there is also a possibility that malicious actors frequently change the name of their group as a countermeasure, for example). An administrator of a community can easily find out what group a user belongs to, but cannot easily verify whether the user of the avatar is the same user who is registered with a group. Hence, regulating admittance into a building or an island based on group affiliation is difficult to administrate effectively.

Another situation unique to virtual worlds that raises a security concern is ascertaining whether a human is controlling the avatar. To with, “Internet bots”, also known as web robots, WWW robots, or simply bots, are software applications that run automated tasks over the Internet (see, e.g., “http://en.wikipedia.org/wiki/Internet_bot”); consequently, bots are able to control an avatar instead of a human controlling the avatar. Typically, bots perform tasks that are both simple and structurally repetitive, and while performance of these tasks is relatively harmless, bots are not limited these types of actions.

For example, programs and algorithms can be used to create bots that mimic actions of avatars within virtual environments. Thus, bots could be a particular issue within Virtual Store Environments, creating a three-dimensional version of email spamming and junk mail. For example, as more retailers enter the realm of Second Life, bots could be used as a virtual marketing technique as avatars are created for no reason other than to promote products, hassle customers, etc. In addition, bots could impersonate a user (i.e. a form of identity theft) and conduct a transaction, thereby committing the true owner of the avatar to a transaction not otherwise intended.

Consequently, determining “who” is behind an avatar is difficult, i.e. determining whether a human is controlling the avatar and whether the human controlling the avatar is accurately described him or herself. Due to this inherent difficulty, malicious users can easily steal another user's identity or can change the status of an avatar (perhaps owned by another user) within the virtual world. This type of malicious use can become troublesome during business transactions, can lead to defamation and may raise privacy concerns.

Therefore, it would be highly desirable to provide a system and method for human identification for use in a virtual world environment as well as other online gaming environments, that unique correlates an avatar to a uniquely identifiable human interacting within the environment.

### SUMMARY

The present invention relates to a method and system trusting avatar identity. More particularly, the present invention is best positioned for environments where trusted identity is needed in an online virtual world, such as access to different virtual areas through ad hoc identification held by avatars. The existence of an avatar, as defined, e.g., by its name and surname is supposed to be unique in the virtual world and the present application seeks to enforce this uniqueness.

Therefore, in light of the above, one object of the present invention is to encrypt the avatar status with a trusted identity server's RSA private key.

Still another object of the present invention is to read the avatar status using trusted identity server RSA public key.

A further object of the present invention is to securely set the status of an avatar to prevent manipulation of the avatar's status.

Therefore, one aspect of the present invention provides a method of setting a security status of an avatar provided for interaction in a virtual world environment, according to an owner of the avatar, in a virtual world, comprising:

retrieving a first certificate associated with the avatar, where the first certificate includes a stored biometric pattern of the owner of the avatar;

generating a challenge to verify the trustworthiness of an avatar that expires within predetermined period of time;

encrypting said challenge with a public key included in a second certificate associated with said owner;

sending the encrypted challenge to said owner;

said owner, encrypting a challenge response using a private key of said owner;

receiving from said owner, within the predetermined period of time, said challenge response, the challenge response including a captured biometric pattern of said owner;

setting the security status of the avatar to trusted when the captured biometric pattern matches the biometric pattern of said owner; otherwise,

setting the security status of the avatar to untrusted.

Another aspect of the present invention provides a system for setting a security status of an avatar, according to an owner of the avatar, in a virtual world, comprising:

means for retrieving a first certificate associated with the avatar, where the first certificate includes a stored biometric pattern of said owner of the avatar;

means for calculating a challenge that expires within predetermined period of time;

means for encrypting said challenge with a public key included in a second certificate associated with said owner;

means for sending the encrypted challenge to said owner;

said owner, means for encrypting a challenge response using a private key of said owner

means for receiving from said owner, within the predetermined period of time, said challenge, said challenge response including a captured biometric pattern of said owner;

means for setting the security status of the avatar to trusted when the captured biometric pattern matched the biometric pattern of said owner; otherwise,

means for setting the security status of the avatar to untrusted.

Yet another aspect of the present invention provides a computer-readable medium, having computer-readable program code embodied therein and adapting a first computing device to perform a method of setting a security status of an avatar provided for interaction in a virtual world environment, comprising:

retrieving a first certificate associated with the avatar, where the first certificate includes a stored biometric pattern of the owner of the avatar;

generating a challenge to verify the trustworthiness of an avatar that expires within predetermined period of time;

encrypting the challenge with a public key included in a second certificate associated with said owner;

sending the encrypted challenge to said owner;

upon receiving an encrypted response from said owner within said predetermined period, decrypting said encrypted response, where the encrypted response includes a captured biometric pattern;

comparing said captured biometric pattern with said stored biometric pattern;

setting the security status of the avatar to trusted when the captured biometric pattern matches the biometric pattern of said owner; otherwise,

setting the security status of the avatar to untrusted.

Further benefits and advantages of the invention will become apparent from a consideration of the following detailed description, given with reference to the accompanying drawing, which specifies and shows preferred embodiments of the invention.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed descriptions of illustrative embodiments when read in conjunction with the accompanying drawings. In each of the drawings below, as well as the respective descriptions, the same numbers are used throughout to reference like components and/or features.

FIG. 1 illustrates a relationship among users, groups, and objects in a virtual world environment.

FIG. 2 shows the components of a system in accordance with an embodiment of the present invention.

FIG. 3 shows a sequence diagram illustrating the procedure, embodying this invention, between the different components of an embodiment of the present invention during avatar creation.

FIG. 4 shows a sequence diagram illustrating a procedure, embodying this invention, between the different components of an embodiment of the present invention when setting the security status of an avatar.

FIG. 5 depicts a general computing environment that, as an example, may be used to practice this invention.

### DETAILED DESCRIPTION

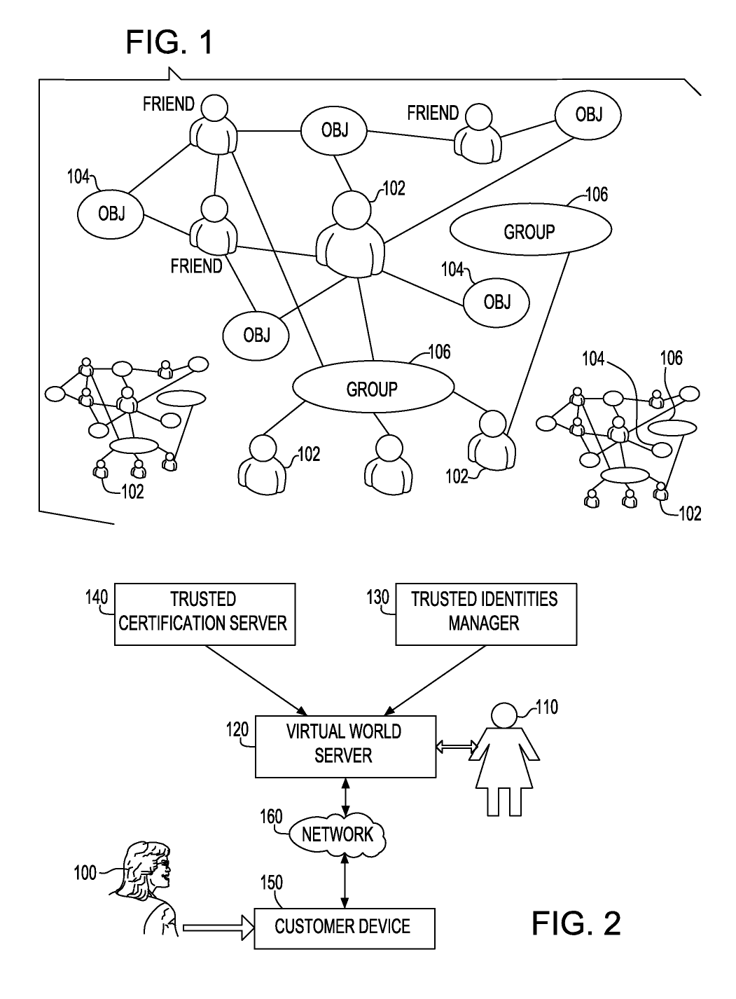

The present invention provides a method and system for securely identifying a user within a virtual world environment. FIG. 1 shows, as an example, a virtual world environment. Participating in the virtual world are users 102, represented in the virtual world to as avatars. In addition, objects 104 and groups of objects 106 populate the virtual world. As mentioned above, each user may belong to a group(s) 106, as a way to identify themselves to users in the virtual world. Typically, a user is not restricted to a single group. In addition, users 102 may form ad-hoc associates with each other, which constitutes friends 110, or an indication of a pre-existing relationship between users.

FIG. 2 shows specific components of a system in accordance with one embodiment of the present invention. In the embodiment shown, Trusted Certification Server 140 authenticates certificates that may be presented by users to verify their identities via an interface to Trusted Certification Server 140—e.g., through a network connection via network 160. Network 160 includes all forms of network technologies and is not limited in any way; for example network 160 may include a public network of computers, the Internet, an intranet, Local Area Network, Wide Area Network, wireless networks, etc. As illustrated in FIG. 2, Trusted Certification Server 140 communicates directly with Virtual World Server 120. According to the discussion above, Virtual World Server 120 is a logical entity that hosts and provides, at client devices, a virtual world and may include Second Life® or any other environment that would constitute a virtual world or part of the 3-D Internet. In addition to Trusted Certification Server 140, Trusted Identities Mgr 130 also communicates directly with Virtual World Server 120.

According to the present application, Trusted Identities Mgr 130 is an entity able to set, request and verify the avatar's owner identity. As shown in FIG. 2, Trusted Identities Mgr 130 is, for example, a server-class computer that is able to securely communication with Virtual World Server 120. Secure communications include, but are not limited to, robustly encrypted direct connections, logical connections that are robustly encrypted (e.g. Virtual Private Network protocols). In addition, Trusted Identities Mgr 130 may be a logical entity (e.g. a software application) that is executed concurrently with Virtual World Server 120 on, for example, a server cluster. In such instances, however, Virtual World Server 120 still requires a secure communications mechanism, albeit a logical one, to communicate with Trusted Identities Mgr 130. Examples of secure communications between logical entities running concurrently include, but are not limited to, secure socket connections between such entities (e.g., SSL) and Secure Inter-Process Communications (SIPC) protocols.

Also illustrated in FIG. 2 is User 100, who is a physical person and the rightful owner of Avatar 110. In addition, Avatar 110 is shown as an avatar virtually participating in a virtual world via Virtual World Server 120. As discussed above, Avatar 110 is not limited to a single virtual world, shown in FIG. 2 as Virtual World Server 120, but rather may interact within numerous virtual worlds and hence numerous virtual world servers.

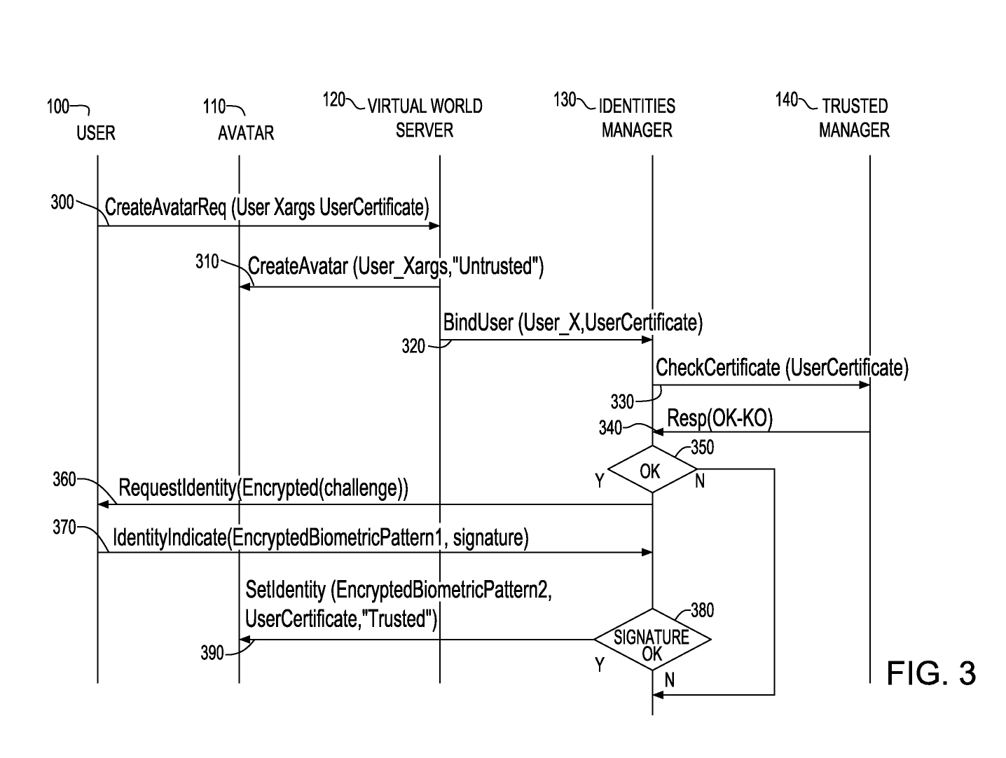

FIG. 3 describes, in detail with reference to components illustrated in FIG. 2, an exemplary process used to create a new avatar according to one embodiment of the present invention. In step 300, User 100 communications a request to Virtual World Server 120 to create Avatar 110, passing as arguments metadata characterizing the avatar and the user's digital certificate. Uses of user certificates within a Public Key Infrastructure (or “PKI”) are well developed in the relevant art, as described, for example, in “Introduction to Public Key Technology and the Federal PKI Infrastructure” (NIST publication SP 800-32, Feb. 26, 2001). Thus, for example, User 100 possesses a user certificate issued by a trusted third party. The user certificate owned by User 100 contains the public key issued by the trusted third party uniquely to User 100 and the certificate may be distributed to others. In addition, a private key is separately issued to User 100 by the trusted third party and User 100 is the only entity in possession of this unique private key. Accordingly, anyone can use the user certificate to send a message to User 100, using the public key found in the user certificate, and the message is secure because only User 100 (who possesses the private key) can decrypt the message. Moreover, User 100 can encrypt a message with the private key and send the message to a recipient in possession of the user certificate and the recipient of that message can verify the authenticity of the message by using the public key stored in the user certificate of User 100 to decrypt the message (see generally, NIST publication SP 800-32, Feb. 26, 2001).

As previously noted, the avatar may or may not be the sole avatar used by User 100; rather, User 100 is simply requesting the creation of an avatar. In addition, the creation of the avatar is not limited to a newly created avatar. For example, User 100 may wish to transport a previously created avatar into a new virtual world and requests Virtual World Server 120 to create an avatar based on those previously created credentials.

In step 310, Virtual World Server 120 creates Avatar 110, as requested, and sets the security status as “Untrusted” for that avatar. At step 320, Virtual World Server 120 communicates a request to Trusted Identities Mgr 130 to bind Avatar 110 with User 100 and to store the owner's identity information as transmitted while creating Avatar 110. Next, in steps 330 and 340, Trusted Identities Mgr 130 communicates a request to trusted Certification server 140 to check the validity of the certificate sent by User 100 during step 300. If Trusted Certification Server 140 determines that the digital certificate presented by User 100 is not valid, as shown in step 350, the creation process ends. According to the embodiment of FIG. 3, Avatar 110 would not be destroyed; however, Avatar 110 would maintain its “Untrusted” security status and User 100 would not be allowed to change that status until he or she can complete all the create avatar steps illustrated in FIG. 3.

If Trusted Certification Server 140 determines that the certificate is valid in step 350, Trusted Identities Mgr 130 calculates a temporary challenge, which expires within a predetermined time, and encrypts the temporary challenge with the public key retrieved from the user certificate. Thereafter, Trusted Identities Mgr 130 communicates the encrypted temporary challenge to User 100 in step 360 to validate the identity of User 100. In one embodiment of the present invention, the temporary challenge is a random set of bits of a predetermined size (e.g., 8 bytes) and the temporary challenge expires after 5 minutes. Use of public keys includes, for example, the RSA public key encryption algorithm and is described in, for example, Boneh, Dan, “Twenty Years of attacks on the RSA Cryptosystem”, Notices of the American Mathematical Society 46(2): pp. 203-213 (1999), incorporated by reference herein.

In step 370, User 100 responds by providing a biometric pattern and a signature communicated for receipt by Trusted Identities Mgr 130. The biometric pattern is preferably captured via a secure device, such as the apparatus described in U.S. patent application Ser. No. ______ (Attorney Docket: FR920080088US1), filed concurrent herewith. The signature includes, for example, a hashing of the biometric pattern concatenated with the received challenge. Hashing is a well developed practice in the relevant art; examples include the MD5 or SHA1 algorithms. The resulting hash is encrypted with the private key of User 100.

In step 380, Trusted Identities Mgr 130 determines whether User 100 responded to the temporary challenge within the predetermined time (e.g., 5 minutes). If Trusted Identities Mgr 130 determines that User 100 has exceed the predetermined time, in one embodiement of the present invention, the status remains “untrusted” and the process ends. When User 100 does respond to the temporary challenge within the predetermined time, Trusted Identities Mgr 130 checks the validity of the signature, as received by User 100. If the signature is acceptable via any means available to verify signatures (see e.g., NIST publication SP 800-32, Feb. 26, 2001), the biometric pattern of User 100, preferably captured via a secure device, is bound to Avatar 110 and stored in a secure location and the user certificate and avatar attains a “trusted” status.

The sequence of steps 360 and 370 may be repeated several times to get several patterns. For example, the security requirements of a particular embodiment of the present invention may require several different patterns (e.g., fingerprints, palm print and iris scan) to be verified to trust an avatar. In another embodiment, several patterns may be required if the first pattern transmitted from User 100 is an insufficient quality and requires a new pattern of a superior quality before the process of FIG. 3 will proceed. In yet another embodiment of the present invention, the sequence of steps 360 and 370 may be retried if the signature is defective. In such an embodiment, Avatar 110 security status will remain “Untrusted” if after a predetermined number of retries the expected number of patterns has not been collected. Consequently, the process illustrated in FIG. 3 will terminate.

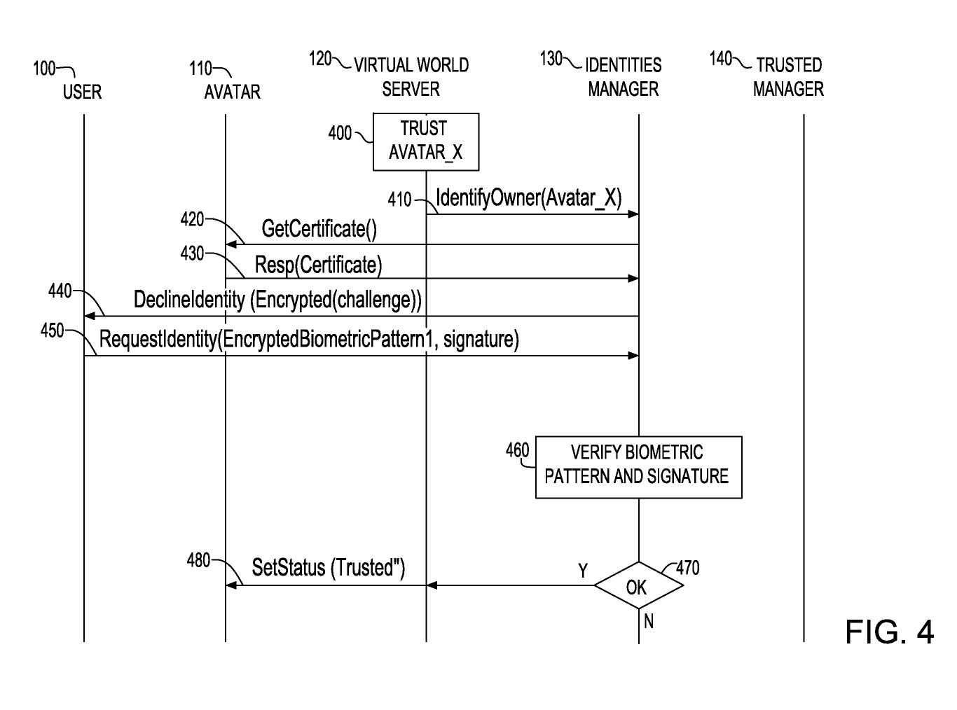

FIG. 4 illustrates an exemplary procedure, according to one embodiment of the present invention and with reference to the components illustrated in the exemplary embodiment of FIG. 2, for setting the security status of an existing avatar. In step 400, Virtual World Server 120 requires verification of an avatar's status, and in particular whether Avatar 110 is trusted. Consequently, in step 410, Virtual World Server 120 communicates a request to Trusted Identity Mgr 130 to verify User 100 is the owner of Avatar 110.

In step 420 and 430, Trusted Identities Mgr 130 retrieves the user certificate associated with Avatar 110. After Trusted Identities Mgr 130 has obtained the user certificate for Avatar 110, Trusted Identities Mgr 130 calculates a temporary challenge and encrypts the temporary challenge with the public key of the User 100 extracted from the certificate retrieved from Avatar 110.

Next, in step 440, Trusted Identities Mgr 130 communicates a request to User 100 to verify his or her identity by sending a response that includes the encrypted temporary challenge. At step 450, User 100 captures his or her biometric data/parameters; e.g., fingerprints, retinal scan, etc. The apparatus used to capture the biometric parameters of User 100 is preferably a secure device, such as the apparatus described in U.S. patent application Ser. No. ______ (Attorney Docket: FR920080088US1) filed concurrent herewith. Upon capturing the requested biometric parameters, User 100 then communicates a signed reply in a manner previously described in FIG. 3 to Trusted Identities Mgr 130.

Trusted Identities Mgr 130 verifies the biometric parameters returned from User 100 (captured as a biometric pattern), in step 460, against the prior stored biometric patterns retrieved for Avatar 110. In addition, Trusted Identities Mgr 130 verifies the validity of the signature received from User 100. If after Trusted Identities Mgr 130 tests the signature and biometric pattern in step 460, and both the signature and biometric pattern are acceptable, then security status of Avatar 110 is set to “Trusted” in step 480. Otherwise the process illustrated in FIG. 4 terminates and the security status remains “Untrusted” for Avatar 110.

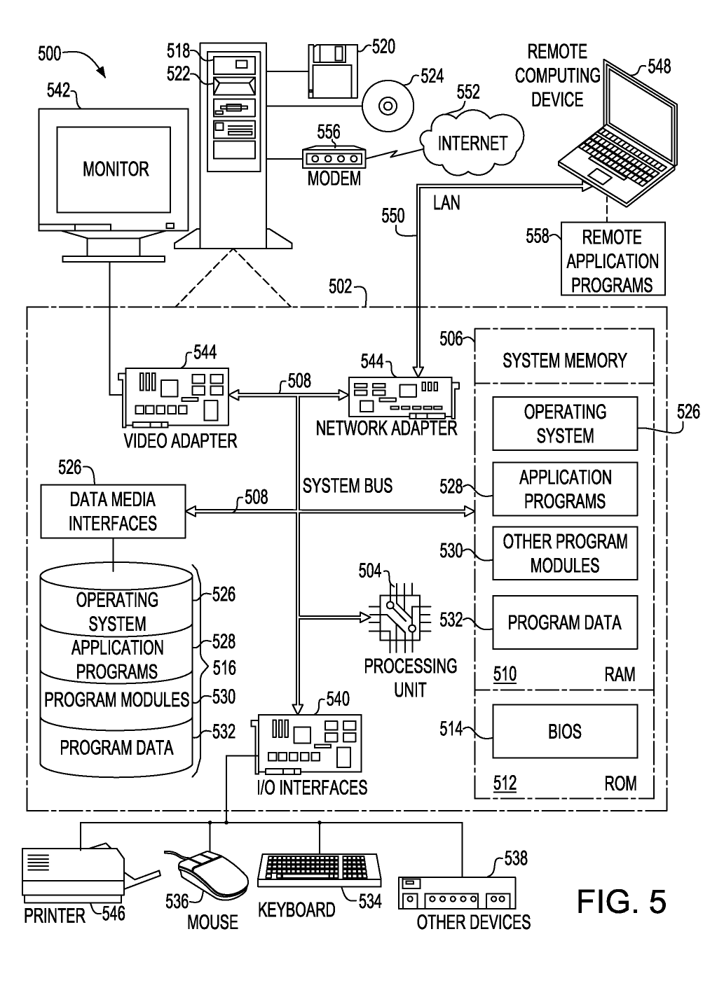

FIG. 5 illustrates a general computer environment 500 that can be used to implement the virtual world avatar verification techniques described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the exemplary computer environment 500.

Computer environment 500 includes a general-purpose computing device in the form of a computer 502. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus, also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown), a magnetic disk drive 518 for reading from and writing to a removable, non-volatile magnetic disk 520 (e.g., a “floppy disk”), and an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternatively, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 504 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546 which can be connected to computer 502 via the input/output interfaces 540.

Computer 502 can operate in a networked environment using logical connections to one or more remote computers, such as a remote computing device 548. By way of example, the remote computing device 548 can be a personal computer, portable computer, a server, a router, a network computer, a peer device or other common network node, and the like. The remote computing device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Both the LAN and WAN form logical connections via wired communication mediums and appropriate communication protocols (such as Ethernet, see e.g., IEEE 802.3-1998 Std) or wireless communication mediums and appropriate communications protocols (such as Wi-Fi; see e.g., IEEE 802.11-2007 Std). Such networking environments are commonplace in homes, offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above are also included within the scope of computer readable media.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of setting a security status of an avatar provided for interaction in a virtual world environment, according to an owner of the avatar, in a virtual world, comprising:
retrieving a first certificate associated with the avatar, where the first certificate includes a stored biometric pattern of the owner of the avatar;
generating a challenge to verify the trustworthiness of an avatar that expires within predetermined period of time;
encrypting said challenge with a public key included in a second certificate associated with said owner;
sending the encrypted challenge to said owner;
said owner, encrypting a challenge response using a private key of said owner;
receiving from said owner, within the predetermined period of time, said challenge response, the challenge response including a captured biometric pattern of said owner;
setting the security status of the avatar to trusted when the captured biometric pattern matches the biometric pattern of said owner; otherwise,
setting the security status of the avatar to untrusted.

2. The method according to claim 1, wherein the first certificate is associated with the avatar by a first processing device unique to the three dimensional virtual world.

3. The method according to claim 2, wherein the second certificate has been issued by a second processing device unique to the three dimensional virtual world.

4. The method according to claim 3, wherein the first processing device associates the first certificate with the avatar only after the second certificate has been validate by the second processing device.

5. The method according to claim 3, further comprising transmitting the second certificate to the second processing device to validate of the second certificate,
wherein the status of the avatar is set to untrusted when the second processing device is unable to validate the second certificate.

6. The method according to claim 1, wherein the challenge response is a hash of the captured biometric pattern and the challenge.

7. The method according to claim 4, wherein the hash is according to at least one of MD5 and SHA 1 hashing algorithms.

8. A system for setting a security status of an avatar, according to an owner of the avatar, in a virtual world, comprising:
means for retrieving a first certificate associated with the avatar, where the first certificate includes a stored biometric pattern of said owner of the avatar;
means for calculating a challenge that expires within predetermined period of time;
means for encrypting said challenge with a public key included in a second certificate associated with said owner;
means for sending the encrypted challenge to said owner;
said owner, means for encrypting a challenge response using a private key of said owner
means for receiving from said owner, within the predetermined period of time, said challenge, said challenge response including a captured biometric pattern of said owner;
means for setting the security status of the avatar to trusted when the captured biometric pattern matched the biometric pattern of said owner; otherwise,
means for setting the security status of the avatar to untrusted.

9. The system according to claim 8, wherein the first certificate is associated with the avatar by a first processing device unique to the three dimensional virtual world.

10. The system according to claim 9, wherein the second certificate has been issued by a second processing device unique to the three dimensional virtual world.

11. The system according to claim 10 wherein the first processing device associates the first certificate with the avatar only after the second certificate has been validate by the second processing device.

12. The system according to claim 10, further comprising means for transmitting the second certificate to the second processing device to validate of the second certificate,
wherein the status of the avatar is set to untrusted when the second processing device is unable to validate the second certificate.

13. The system according to claim 8, wherein the challenge response is a hash of the captured biometric pattern and the challenge.

14. The system according to claim 13, wherein the hash is according to at least one of MD5 and SHA 1 hashing algorithms.

15. A computer-readable medium, having computer-readable program code embodied therein and adapting a first computing device to perform a method of setting a security status of an avatar provided for interaction in a virtual world environment, comprising:
retrieving a first certificate associated with the avatar, where the first certificate includes a stored biometric pattern of the owner of the avatar;
generating a challenge to verify the trustworthiness of an avatar that expires within predetermined period of time;
encrypting the challenge with a public key included in a second certificate associated with said owner;
sending the encrypted challenge to said owner;
upon receiving an encrypted response from said owner within said predetermined period, decrypting said encrypted response, where the encrypted response includes a captured biometric pattern;
comparing said captured biometric pattern with said stored biometric pattern;
setting the security status of the avatar to trusted when the captured biometric pattern matches the biometric pattern of said owner; otherwise,
setting the security status of the avatar to untrusted.

16. The computer-readable medium according to claim 15, wherein the first certificate is associated with the avatar by a second computing device unique to the three dimensional virtual world.

17. The computer-readable medium according to claim 16, wherein the second certificate has been issued by a third computing device unique to the three dimensional virtual world.

18. The computer-readable medium according to claim 17, wherein the second computing device associates the first certificate with the avatar only after the second certificate has been validate by the third computing device.

19. The computer-readable medium according to claim 17, further comprising transmitting the second certificate to the third computing device to validate of the second certificate,
wherein the status of the avatar is set to untrusted when the third computing device is unable to validate the second certificate.

20. The computer-readable medium according to claim 15, wherein encrypting the challenge is performed according to an RSA encryption algorithm.
